(19) United States
(12) Patent Application Publication
(10) Pub. No.: US 2018/0257079 A1
(43) Pub. Date: Sep. 13, 2018

(54) ADJUSTABLE TIPPING-PREVENTING TEMPERATURE-CONTROLLING TEST TUBE RACK FOR SMART MEDICAL TESTING

(71) Applicant: Sze Chun Jack WONG, Hong Kong (HK)

(72) Inventor: Sze Chun Jack WONG, Hong Kong (HK)

(21) Appl. No.: 15/496,194

(22) Filed: Apr. 25, 2017

(30) Foreign Application Priority Data
Mar. 8, 2017 (CN) 201710135982.9

(51) Int. Cl. B01L 9/06; G01N 35/00; B01L 9/00

(52) U.S. Cl. CPC B01L 9/06; G01N 35/00584; B01L 9/50; G01N 2035/00346; B01L 2300/18; B01L 2300/0609; B01L 2200/025; B01L 2200/146; B01L 2200/147; B01L 2200/143; B01L 2300/06

(57) ABSTRACT

The present invention relates to an adjustable tipping-preventing temperature-controlling test tube rack for smart medical testing comprising a stand, a temperature control mechanism, an adjustable stand, and a shaking mechanism. A slot rail, butterfly bolts and a magnet are disposed on the stand. The shaking mechanism comprises a heating plate mounted inside a chamber of the case and a micro pump connected to the chamber of the case. The shaking mechanism comprises a motor, a drive crank, a drive piece, slide rail and sliders. The adjustable stand comprises a stainless steel fixed piece, a magnetic adjustment plate, and supporting plates. The stainless steel fixed piece is connected to the magnetic adjustment plate. The test tube rack has the advantages of being reasonable, simple, convenient, fixedly mounted, good temperature control performance, good adaptability, high level of automation, precipitation preventing, can effectively solve the problem of the test tube rack tipping over easily.

### FIELD OF INVENTION

The present invention relates to the field of medical laboratory equipment, in particular to an adjustable tipping-preventing temperature-controlling test tube rack for smart medical testing.

### BACKGROUND OF INVENTION

Medical laboratory is a field of using modern physical and chemical means for medical diagnosis, mainly researching about how to provide bases for clinical diagnosis and treatment through laboratory skills and medical equipment. Presently, the test tube racks used in clinical medical tests do not possess temperature control and test tube shaking mechanisms, and since the test time is relatively long during tests, contents in the test tube may precipitate due to prolonged idling, changes in temperature may cause the activity or structure and composition of the test object to change, and causes inaccuracies in the testing results. As sizes of test tubes differ, different test tube racks need to be provided for different sizes of test tubes, which waste resources. Also, a weight is generally not disposed at the base of the test tube racks, making the test tubes easy to tip over.

### SUMMARY OF INVENTION

The technical problem to be solved by the present invention is: to overcome the aforementioned problem, an adjustable tipping-preventing temperature-controlling test tube rack for smart medical testing is provided. The test tube rack has the advantages of being reasonable, simple, convenient, fixedly mounted, good temperature control performance, good adaptability, high level of automation, precipitation preventing, can effectively solve the problem of the test tube rack tipping over easily.

The technical solution used in the present invention to solve the technical problem is: an adjustable tipping-preventing temperature-controlling test tube rack for smart medical testing comprising a stand, a temperature control mechanism, an adjustable stand, and a shaking mechanism. A slot rail for slotting to a test bed, butterfly bolts for locking the stand to the test bed and a magnet for attracting to ferric test beds are disposed on the stand.

The shaking mechanism comprises a case having a test tube receiving space, a heating plate mounted inside a chamber of the case and a micro pump connected to the chamber of the case.

The shaking mechanism comprises a motor mounted on the stand, a drive crank, a drive piece, two slide rails disposed on the stand and two sliders disposed inside the slide rails. The two ends of the drive crank are drivably connected to the motor and the slider respectively, a speed sensor is further disposed on the drive crank. A connection rod is disposed on the slider, the connection rod is connected to the case, a pressure sensor is further disposed at a joint between the connection rod and the case. Through slots are disposed at two ends of the drive piece, the connection rod is inserted through the through slots, a center of the drive piece is hinged to the stand.

The adjustable stand comprises a stainless steel fixed piece disposed on the case, a magnetic adjustment plate, and a number of supporting plates slotted into the magnetic adjustment plate. A cavity is opened at the stainless steel fixed piece, a tension spring and a latch is disposed inside the cavity. One end of the latch is in contact with the tension spring, another end of the latch penetrates through the stainless steel fixed piece and latches to the groove of the magnetic adjustment plate.

In a preferred embodiment, the test tube receiving space is made of meshed plate.

In a preferred embodiment, a temperature sensor is disposed inside the chamber of the case.

In a preferred embodiment, the temperature sensor, the micro pump, the heating plate, the speed sensor, and the pressure sensor are separately electrically connected to the controller mounted on the stand.

In a preferred embodiment, the supporting plate is made of stainless steel, the supporting plate and the magnetic adjustment plate complementally fit with each other.

In a preferred embodiment, a number of through holes corresponding to the test tube receiving space is disposed on the supporting plate.

In a preferred embodiment, the grooves are vertically uniformly disposed on the magnetic adjustment plate.

The advantage of the present invention is: the adjustable tipping-preventing temperature-controlling test tube rack for smart medical testing of the present invention comprises a stand, a temperature control mechanism, an adjustable frame and a shaking mechanism. The stand is made of weighted metal plate with magnets inserted, can prevent the test tube rack tipping over due to being top heavy, and further can directly slot onto the test bed through the slot rail of the stand. The temperature control mechanism achieves a uniform temperature inside the chamber of the case by having a heating plate disposed inside the case with a test tube receiving space and having a micro pump to pump air inside the case, thereby increasing temperate control performance. Slidably connected stainless steel fixed piece and magnetic adjustment plate uses a spring-driven latch to set its position, and generates damping when adjusting the relative position between the stainless steel fixed piece and magnetic adjustment plate as well as between the magnetic adjustment plate and the supporting plate, as such preventing damaging of test tubes caused by sudden dropping of frame. The shaking mechanism has a simple structure, and can mimic a human hand shaking the test tube in a left-right motion. Furthermore, the temperature sensor disposed inside the case, the speed sensor disposed in the shaking mechanism and the pressure sensor coordinates corresponding with the controller to control the temperature and shaking speed of the test tube rack. The test tube rack has the advantages of being reasonable, simple, convenient, fixedly mounted, good temperature control performance, good adaptability, high level of automation, precipitation preventing, can effectively solve the problem of the test tube rack tipping over easily.

### BRIEF DESCRIPTION OF DRAWINGS

The present invention is further explained below with the accompanying drawings and embodiments.

FIG. 1 is an overall structural schematic diagram of an adjustable tipping-preventing temperature-controlling test tube rack for smart medical testing according to the present invention.

FIG. 2 is a side structural schematic diagram of an adjustable tipping-preventing temperature-controlling test tube rack for smart medical testing according to the present invention.

FIG. 3 is a structural schematic diagram of a shaking mechanism of an adjustable tipping-preventing temperature-controlling test tube rack for smart medical testing according to the present invention.

FIG. 4 is a structural schematic diagram of stainless steel fixed piece and magnetic adjustment plate of an adjustable tipping-preventing temperature-controlling test tube rack for smart medical testing according to the present invention.

Reference numbers in the drawings: 1 stand, 11 slot rail, 12 magnet, 13 butterfly bolt, 2 temperature control mechanism, 20 case, 21 test tube receiving space, 22 heating plate, 23 temperature sensor, 24 micro pump, 25 controller, 3 adjustable stand, 31 stainless steel fixed piece, 310 rail, 311 cavity, 312 tension spring, 313 latch, 32 magnetic adjustment plate, 321 groove, 33 supporting plate, 34 through hole, 4 shaking mechanism, 41 motor, 42 drive crank, 421 speed sensor, 43 drive piece, 431 through slot, 44 slider, 441 connection rod, 442 pressure sensor, 45 slide rail.

### DETAILED DESCRIPTION OF INVENTION

The present invention is further explained below along with the accompanying drawings. The drawings are all simplified schematic diagrams which only illustrates the basic structure of the present invention, as such only the components material to the present invention are shown.

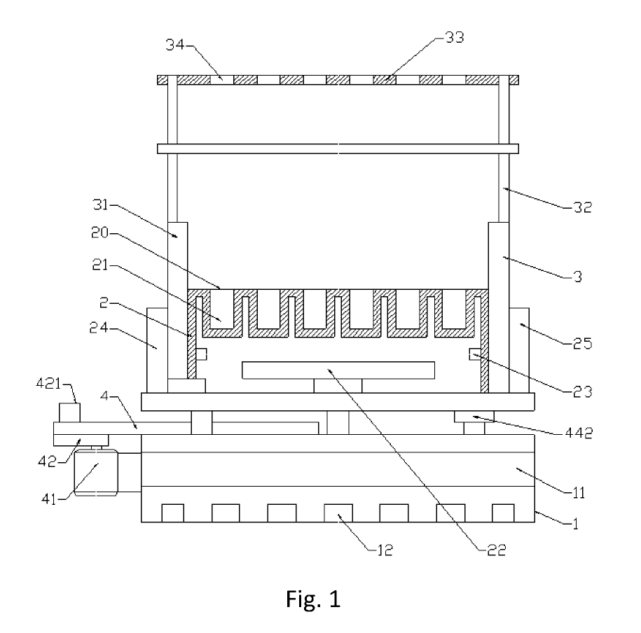

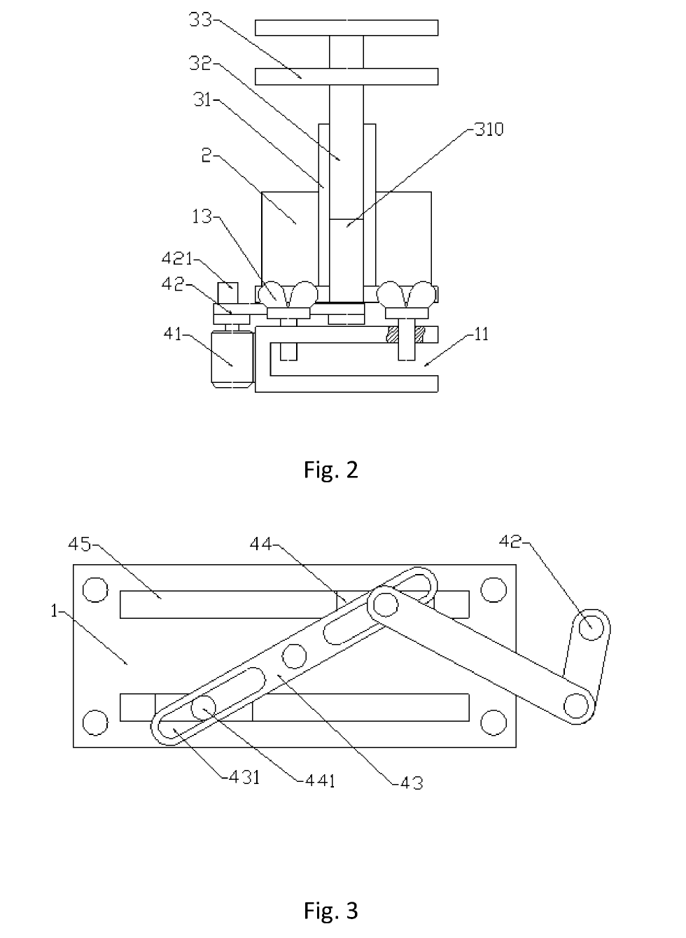

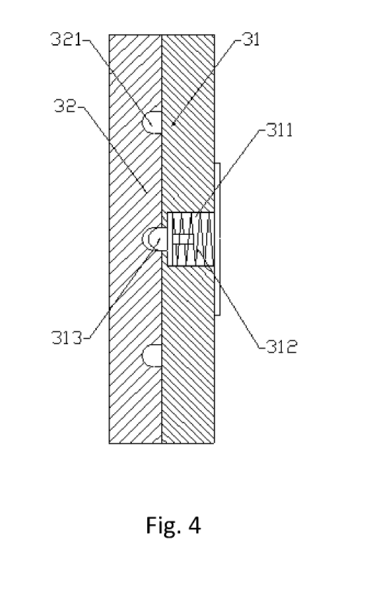

An adjustable tipping-preventing temperature-controlling test tube rack for smart medical testing is shown in FIGS. 1-4. The device comprises a stand 1, a temperature control mechanism 2, an adjustable stand 3, and a shaking mechanism 4. A slot rail 11 for slotting to a test bed, butterfly bolts 13 for locking the stand 1 to the test bed and a magnet 12 for attracting to ferric test beds are disposed on the stand 1.

The shaking mechanism 2 comprises a case 20 having a test tube receiving space 21, a heating plate 22 mounted inside a chamber of the case 20 and a micro pump 24 connected to the chamber of the case 20.

The shaking mechanism 4 comprises a motor 41 mounted on the stand 1, a drive crank 42, a drive piece 43, two slide rails 45 disposed on the stand 1 and two sliders 44 disposed inside the slide rails 45. The two ends of the drive crank 42 are drivably connected to the motor 41 and the slider 44 respectively, a speed sensor 421 is further disposed on the drive crank 42. A connection rod 441 is disposed on the slider 44, the connection rod 441 is connected to the case 20, a pressure sensor 442 is further disposed at a joint between the connection rod 441 and the case 20. Through slots 431 are disposed at two ends of the drive piece 43, the connection rod 441 is inserted through the through slots 431, a center of the drive piece 43 is hinged to the stand 1.

The adjustable stand 3 comprises a stainless steel fixed piece 31 disposed on the case 20, a magnetic adjustment plate 32, and a number of supporting plates 33 slotted into the magnetic adjustment plate 32. A cavity 311 is opened at the stainless steel fixed piece 31, a tension spring 312 and a latch 313 is disposed inside the cavity 311. One end of the latch 313 is in contact with the tension spring 312, another end of the latch 313 penetrates through the stainless steel fixed piece 31 and latches to the groove 321 of the magnetic adjustment plate 32.

The test tube receiving space 21 is made of meshed plate. A temperature sensor 23 is disposed inside the chamber of the case 20. The temperature sensor 23, the micro pump 24, the heating plate 22, the speed sensor 421, and the pressure sensor 442 are separately electrically connected to the controller 25 mounted on the stand 1. The supporting plate 33 is made of stainless steel, the supporting plate 33 and the magnetic adjustment plate 32 complementally fit with each other. A number of through holes 34 corresponding to the test tube receiving space 21 is disposed on the supporting plate 33. The grooves 321 are vertically uniformly disposed on the magnetic adjustment plate 32.

The adjustable tipping-preventing temperature-controlling test tube rack for smart medical testing of the present invention comprises a stand, a temperature control mechanism, an adjustable frame and a shaking mechanism. The stand is made of weighted metal plate with magnets inserted, can prevent the test tube rack tipping over due to being top heavy, and further can directly slot onto the test bed through the slot rail of the stand. The temperature control mechanism achieves a uniform temperature inside the chamber of the case by having a heating plate disposed inside the case with a test tube receiving space and having a micro pump to pump air inside the case, thereby increasing temperate control performance. Slidably connected stainless steel fixed piece and magnetic adjustment plate uses a spring-driven latch to set its position, and generates damping when adjusting the relative position between the stainless steel fixed piece and magnetic adjustment plate as well as between the magnetic adjustment plate and the supporting plate, as such preventing damaging of test tubes caused by sudden dropping of frame. The shaking mechanism has a simple structure, and can mimic a human hand shaking the test tube in a left-right motion. Furthermore, the temperature sensor disposed inside the case, the speed sensor disposed in the shaking mechanism and the pressure sensor coordinates corresponding with the controller to control the temperature and shaking speed of the test tube rack. The test tube rack has the advantages of being reasonable, simple, convenient, fixedly mounted, good temperature control performance, good adaptability, high level of automation, precipitation preventing, can effectively solve the problem of the test tube rack tipping over easily.

As revealed by the preferred embodiments of the present invention, based on the aforementioned description, a person skilled in the art can make various modifications and adjustments without departing from the technical concept of the present invention. The technical scope of the present invention is not limited to the specification but is defined by the scope of the claims.

What is claimed is:

1. An adjustable tipping-preventing temperature-controlling test tube rack for smart medical testing comprising a stand, a temperature control mechanism, an adjustable stand, and a shaking mechanism; a slot rail for slotting to a test bed, butterfly bolts for locking the stand to the test bed and a magnet for attracting to ferric test beds are disposed on the stand;
the shaking mechanism comprises a case having a test tube receiving space, a heating plate mounted inside a chamber of the case and a micro pump connected to the chamber of the case; the shaking mechanism comprises a motor mounted on the stand, a drive crank, a drive piece, two slide rails disposed on the stand and two sliders disposed inside the slide rails; the two ends of the drive crank are drivably connected to the motor and the slider respectively, a speed sensor is further disposed on the drive crank; a connection rod is disposed on the slider, the connection rod is connected to the case, a pressure sensor is further disposed at a joint between the connection rod and the case; through slots are disposed at two ends of the drive piece, the connection rod is inserted through the through slots, a center of the drive piece is hinged to the stand;
the adjustable stand comprises a stainless steel fixed piece disposed on the case, a magnetic adjustment plate, and a number of supporting plates slotted into the magnetic adjustment plate; a cavity is opened at the stainless steel fixed piece, a tension spring and a latch is disposed inside the cavity; one end of the latch is in contact with the tension spring, another end of the latch penetrates through the stainless steel fixed piece and latches to the groove of the magnetic adjustment plate.

2. The adjustable tipping-preventing temperature-controlling test tube rack for smart medical testing according to claim 1, characterized in that: the test tube receiving space is made of meshed plate.

3. The adjustable tipping-preventing temperature-controlling test tube rack for smart medical testing according to claim 1, characterized in that: a temperature sensor is disposed inside the chamber of the case.

4. The adjustable tipping-preventing temperature-controlling test tube rack for smart medical testing according to claim 1, characterized in that: the temperature sensor, the micro pump, the heating plate, the speed sensor, and the pressure sensor are separately electrically connected to the controller mounted on the stand.

5. The adjustable tipping-preventing temperature-controlling test tube rack for smart medical testing according to claim 1, characterized in that: the supporting plate is made of stainless steel, the supporting plate and the magnetic adjustment plate complementally fit with each other.

6. The adjustable tipping-preventing temperature-controlling test tube rack for smart medical testing according to claim 1, characterized in that: a number of through holes corresponding to the test tube receiving space is disposed on the supporting plate.

7. The adjustable tipping-preventing temperature-controlling test tube rack for smart medical testing according to claim 1, characterized in that: the grooves are vertically uniformly disposed on the magnetic adjustment plate.
